(19) United States
(12) Patent Application Publication
(10) Pub. No.: US 2009/0187398 A1
(43) Pub. Date: Jul. 23, 2009

(54) Script Selection Based On SIP Language Preference

(75) Inventor: Charles Wrobel, Duvall, WA (US)

Correspondence Address: AVAYA INC., 307 MIDDLETOWN-LINCROFT ROAD, ROOM 1N-391, LINCROFT, NJ, 07738, US

(73) Assignee: Avaya Technology LLC, Basking Ridge, NJ (US)

(21) Appl. No.: 12/016,450

(22) Filed: Jan. 18, 2008

(51) Int. Cl. G06F 17/20

(52) U.S. Cl. 704/8

(57) ABSTRACT

The “Accept-language” header field of a first Session Initiative Protocol (SIP) message identifies the preferred language of a first party to a communication, a database correlates languages with writing scripts, and the correlation is used to populate the “P-Asserted-Identity”, “From”, or “Contact” header field of a second SIP message with the name of a second party to the communication expressed in the writing script of the first party's preferred language.

### TECHNICAL FIELD

This invention relates to telecommunications.

### BACKGROUND OF THE INVENTION

The Session Initiation Protocol (SIP) is commonly used to set up and control telecommunications such as Voice over Internet Protocol (VoIP) calls. SIP protocol messages include an “Accept-language” field that identifies the language that is preferred by the message sender for reason phrases, session description, status responses carried as messages bodies, or call routing based on language. SIP protocol messages further include a “P-Asserted-Identify” field that is used to convey the name of the message's sender for display to the message's recipient as a “caller ID”.

Users desire to see the caller ID information in their native writing script, that is, in the character set in which their native language is natively written. For example, speakers of Western European and African languages will desire to see caller ID information written in Latin (Roman) script, speakers of most Indian languages will desire to see the information written in Devanagari script, speakers of most Middle Eastern languages will desire to see the information written in Arabic script, and speakers of Chinese will desire to see the information written in Han script. But the SIP standard does not specify a way for automatically determining what a user's preferred written script is and for providing caller ID information to the user in the preferred script.

### SUMMARY OF THE INVENTION

This invention is directed to solving these and other problems and disadvantages of the prior art. According to an aspect of the invention, a preferred language is determined from the contents of an “Accept-language” header field of a received first Session Initiation Protocol (SIP) message, a writing script that corresponds to the preferred language is selected, and information expressed in the selected writing script is sent in at least one of a “P-Asserted-Identify”, “From”, or “Contact” header field of a second SIP message. Illustratively, the first SIP message is received from a first party to a communication by a second party to the communication, and the information is an identifier—the name, for example—of the second party. The second SIP message is sent by the second party to the first party. A calling or a called party is thus able to receive via a SIP message the identity of their counterpart in the call expressed in the writing script of the party's preferred language (e.g., the party's native script).

Embodiments of the invention include both a method as well as a corresponding apparatus for performing the method, and a computer-readable medium that contains instructions which, when executed in a computer, cause the computer to perform the method.

### BRIEF DESCRIPTION OF THE DRAWING

These and other features and advantages of the invention will become more apparent from considering the following description of an illustrative embodiment of the invention together with the drawing, in which:

FIG. 1 is a block diagram of a telecommunications system that includes an illustrative embodiment of the invention; and

FIG. 2 is a flowchart of call-establishment operations of the system of FIG. 1.

### DETAILED DESCRIPTION

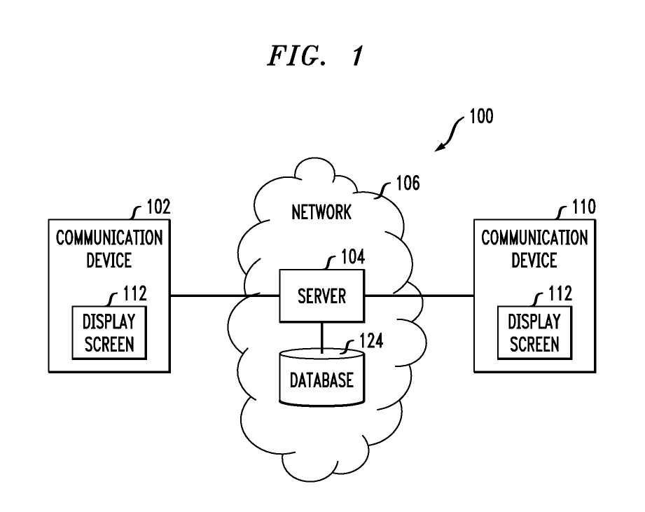

FIG. 1 shows a communications system 100 comprising two or more communication devices 102, 110 interconnected by at least one communications network 106. Each device 102, 110 has a display screen 112. Within network 100, devices 102, 110 connect to, and are served by, a server 104. Alternatively, each device 102, 110 may be served by a different server of network 106. Communications system 100 may be any desired communications system that uses the Session Initiation Protocol (SIP) to establish and control communications between devices 102, 100. By way of example only, network 106 comprises a data network such as the Internet or a local area network, server 104 comprises a communications server such as a proxy, communications manager, or VoIP private branch exchange, and communication devices 102, 100 comprise any desired devices such as wired or wireless VoIP telephones, personal digital assistants, personal computers, etc. Other than that it uses the SIP protocol, the type and structure of the system 100 or any of its components is immaterial. As described so far, system 100 is conventional.

According to an aspect of the invention, server 104 has access to a language-to-script translation database 124. If multiple servers serve devices 102,110, each server may share one copy of database 124, or each server may have its own copy of database 124. Database 124 correlates languages with writing scripts that are natively used to express (write) those languages. Each script correlates with one or more languages.

Within server(s) 104, each device 102,110 is administered with its properties. These properties include the address—e.g., the phone number—of the device, an identifier of the preferred (e.g., native) language of the owner/user of the device, the native name of the owner/user of the device expressed in the native writing script of the owner's/user's native language (if the native writing script is not Latin) and optionally also in other writing scripts, and the owner's/user's name expressed in the Latin (Roman) writing script.

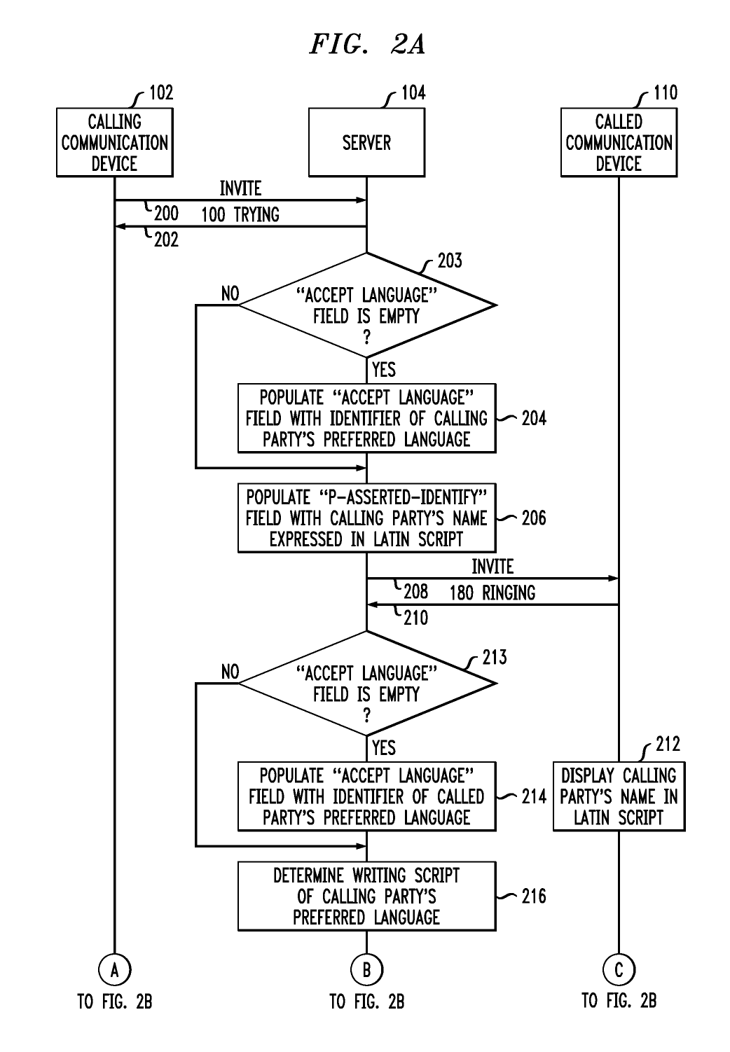

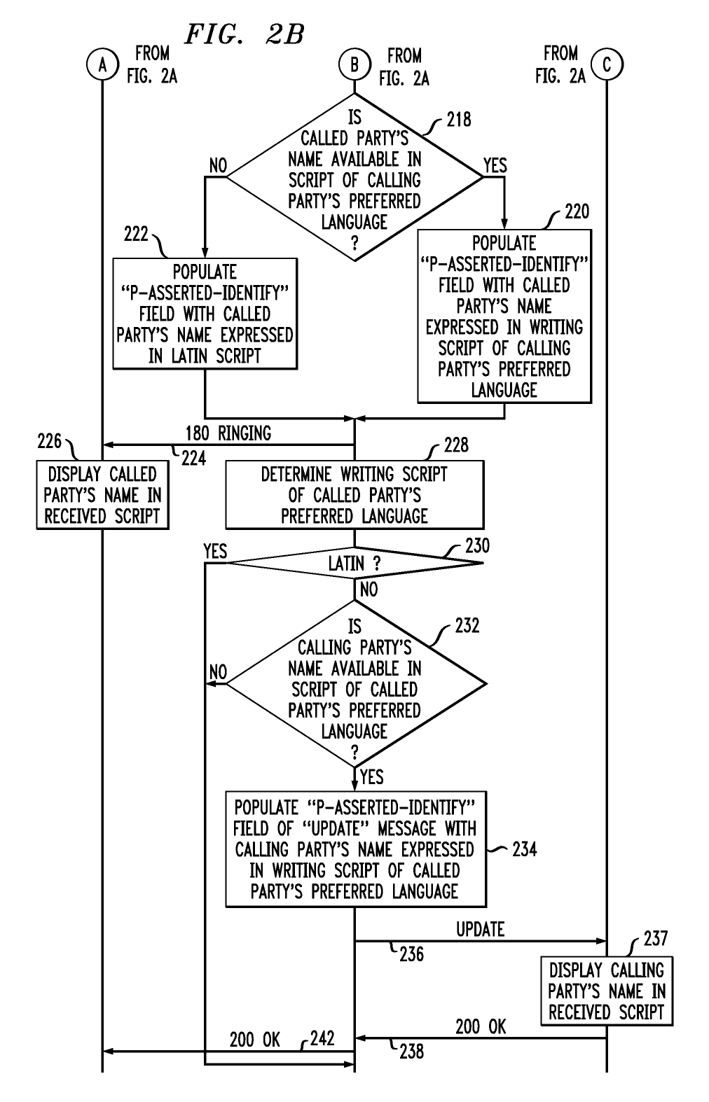

FIG. 2 shows the call-establishment operations of system 100 that are germane to an understanding of the invention. FIG. 2 assumes that a user of communication device 102 is the calling party and that a user of communication device 110 is the called party. When the calling party initiates a call to the called party, communication device 102 sends a conventional SIP “invite” message to server 104, at step 200. This SIP “invite” message may identify the preferred language of the calling party in its “Accept-language” header field. Server 104 responds by returning a conventional SIP “100 trying” message to communication device 102, at step 202. Server 104 checks if the “Accept-language” header field of the “invite” message already identifies the calling party's preferred language, at step 203. If not, server 104 looks up the calling party's name and preferred language in its administration records and populates the “Accept-language” field of the “invite” message with an identifier of the calling party's preferred language, at step 204. In either case, server 104 also populates the “P-Asserted-Identify” field of the “invite” message with the calling party's name expressed in the Latin script, at step 206. Server 104 then sends the “invite” message to communication device 110 of the called party, at step 208.

In response to receiving the “invite” message, communication device 110 returns a conventional SIP “180 ringing” message to server 104, at step 210. This “180 ringing” message may identify the preferred language of the called party in its “Accept-language” header field. Device 110 also displays the received calling party's name, i.e., expressed in the Latin script, on display 112 of device 110, at step 212.

In response to receipt of the “180 ringing” message, server 104 checks if the “Accept-language” header field of the “180 ringing” message already identifies the called party's preferred language, at step 213. If not, server 104 looks up the called party's preferred language in its administrative records and populates the “Accept-language” field of the “180 ringing” message with an identifier of the called party's preferred language, at step 214. In either case, server 104 then uses database 124 to determine the writing script of the calling party's preferred language, at step 216, and checks if its administrative records contain the called party's name expressed in the determined writing script, at step 218. If so, server 104 populates the “P-Asserted-Identify” field of the “180 ringing” message with the called party's name expressed in the determined writing script, at step 220; if not, server 104 populates the “P-Asserted-Identify” field of the “180 ringing” message with the called party's name expressed in the Latin script, at step 222. Server 104 then sends the “180 ringing” message to calling communication device 102, at step 224.

In response to receipt of the “180 ringing” message, communication device 102 displays the received called party's name, i.e., expressed either in the script of the calling party's preferred language or in the Latin script, on display 112 of device 102, at step 226.

After it has sent the “180 ringing” message to communication device 102, server 104 uses database 124 to determine the writing script of the called party's preferred language, at step 228. If the preferred language uses a non-Latin script, as determined at step 230, server 104checks if its administrative records contain the calling party's name expressed in the determined non-Latin writing script, at step 232. If so, server 104 populates the “P-Asserted-Identify” field of a SIP “update” message with the calling party's name expressed in the determined writing script, at step 234 and sends the “update” message to communication device 110, at step 236.

In response to receiving the “update” message, communication device 110 displays on its display 112 the calling party's name in whatever script it received, at step 237, and returns a “200 OK” message to server 104, at step 238.

In response to receiving the “200 OK” message, from called communication device 110, server 104 forwards it to calling communication device 102, at step 242.

A call is now established between services 102 and 110, and display screens 112 both communication devices 102 and 110 are now preferably displaying the other party's name in the writing script of their party's preferred language.

Of course, various changes and modifications to the illustrative embodiment described above will be apparent to those skilled in the art. For example, the “From” or “Contact” header fields of SIP messages may be used instead of the “P-Asserted-Identify” header field to convey a party's identity. The server 104 may cache (save) the preferred language of a called party so that the next time that party's phone is called, the server knows in advance the called party's language preference. This means that the initial “invite” message will have the calling party name in the “P-Asserted-Identity” header field in the writing script of the called party, and the server won't have to send the “update” message the second time that the same number is called. Also, the called phone may choose to show both versions of the calling party's name, that is, the name in the Latin script (sent in the “invite” message) along with the name in the native script (sent in the “update” message). These changes and modifications can be made without departing from the spirit and the scope of the invention and without diminishing its attendant advantages. It is therefore intended that such changes and modifications be covered by the following claims except insofar as limited by the prior art.

What is claimed is:

1. A method comprising:
determining, from content of a first field of a received first Session Initiation Protocol (SIP) message, a preferred language;
selecting a writing script that corresponds to the determined preferred language; and
sending a second SIP message carrying, in a second field, information expressed in the selected writing script.

2. The method of claim 1 wherein:
the first field comprises an “Accept-language” field, and the second field comprises one of a “P-Asserted-Identity”, “From”, and “Contact” field.

3. The method of claim 1 wherein:
determining comprises
receiving the first SIP message from a first party to a communication, and
determining the preferred language of the first party; and
sending comprises
sending the second SIP message to the first party, wherein the information comprises and identifier of a second party to the communication.

4. The method of claim 3 further comprising:
displaying,
in the selected writing script, the identifier of the second party to the first party.

5. The method of claim 4 wherein:
the identifier comprises a name of the second party.

6. The method of claim 1 wherein:
selecting comprises
determining the writing script from contents of a database that correlates writing scripts with languages.

7. A method comprising:
sending a first Session Initiation Protocol (SIP) message having a
first field whose contents identify a preferred language;
in response, receiving a second SIP message carrying, in a second field, information expressed in a writing script that corresponds to the preferred language; and
displaying the information expressed in the writing script.

8. The method of claim 7 further comprising:
selecting, on a basis of the preferred language identified by the
sent SIP message, the writing script that corresponds to the preferred language.

9. The method of claim 7 wherein:
the first field comprises an “Accept-language” field, and
the second field comprises one of a “P-Asserted-Identify”, “From”, and “Contact” field.

10. The method of claim 7 wherein:
sending comprises
sending the first SIP message to a second party to a communication, wherein the content of the first field identifies a preferred language of a first party to the communication;
receiving comprises
receiving the second SIP message from the second party, wherein the second field carries an identifier of the second party; and
displaying comprises
displaying the identifier expressed in the writing script to the first party.

11. A computer-readable medium comprising instructions which, when executed by a computer, perform the method of one of claims 1-10.

12. An apparatus comprising:
a source of information correlating writing scripts with languages;
an input and output for receiving and sending Session Initiation Protocol (SIP) messages; and
an entity responsive to receipt of a first SIP message for determining, from contents of a first field of the first SIP message, a preferred language, for determining from the source of information a writing script that corresponds to the preferred language, and for sending a second SIP message carrying, in a second field, information expressed in the determined writing script.

13. The apparatus of claim 12 wherein:
the first field comprises an “Accept-language” field, and
the second field comprises one of a “P-Asserted-Identity”, “From”, and “Contact” field.

14. The apparatus of claim 12 wherein:
the information comprises an identifier of a second party to a communication expressed in a writing script that corresponds to a preferred language of a first party to the communication.

15. The apparatus of claim 14 wherein:
the identifier comprises a name of the second party for displaying to the first party.
